(19) United States
(12) Patent Application Publication
(10) Pub. No.: US 2026/0165348 A1
(43) Pub. Date: Jun. 18, 2026

(54) LOW-SUGAR DAIRY BEVERAGES

(71) Applicant: SOCIETE DES PRODUITS NESTLE S.A., VEVEY (CH)

(72) Inventors: Ying Zheng, Dublin, OH (US); Alexander Sher, Dublin, OH (US); Virginie Kapchie, Dublin, OH (US); Jun-Tse Ray Fu, Dublin, OH (US)

(21) Appl. No.: 19/535,129

(22) Filed: Feb. 10, 2026

Related U.S. Application Data
(63) Continuation of application No. 15/312,109, now abandoned.
(60) Provisional application No. 62/001,801, filed on May 22, 2014.

(51) Int. Cl. A23L 2/52; A23C 9/154; A23L 2/56

(52) U.S. Cl. CPC A23L 2/52; A23C 9/1544; A23L 2/56; A23V 2002/00

(57) ABSTRACT

Ready to drink low sugar flavored dairy beverages are provided, and methods for making such beverages are also provided. The beverage can include a dairy component, a flavor component, and a stabilizing system comprising a first stabilizing component and a second stabilizing component. The flavor component can be at least one of a cocoa component or a fruit flavoring component. The first stabilizing component is microcrystalline cellulose, carboxymethyl cellulose and further comprising carrageenans, and the second stabilizing component is at least one of gellan or a modified starch. Sugar can be present in the beverage in an amount up to about 4.5% of the beverage. The beverage can be aseptic and stable in a homogenous state for at least three months in ambient storage and preferably at least six months in ambient storage.

### CROSS REFERENCE TO RELATED APPLICATIONS

The present application is a continuation of U.S. patent application Ser. No. 15/312,109 filed Nov. 17, 2016, which is a National Stage of International Application No. PCT/EP2015/060989 filed May 19, 2015, which claims priority to U.S. Provisional Application Ser. No. 62/001,801 filed May 22, 2014, the entire contents of which are incorporated herein by reference.

### BACKGROUND

The present disclosure generally relates to nutritional products. More specifically, the present disclosure relates to ready to drink (“RTD”) reduced sugar beverages containing a dairy component, a flavor component and a stabilizing system and also relates to methods for making same.

The current trend is that consumers are more health conscious and are looking for healthier beverages with less sugar and calories but without compromising the product taste and texture. In addition, consumers demand a healthier beverage, yet they are not willing to give up the original, indulgent mouthfeel they grew up with and remember, also denoted as richness, texture or creaminess, of the beverages. Thus, many RTD beverages are transitioning from high sugar versions to versions with less sugar to limit the calories in the beverage. However, sugar reduction results in a thin, less pleasing mouthfeel of the beverages. Therefore, there is a need for a solution that improves and compensates the loss of mouthfeel in reduced sugar RTD dairy beverages to maintain the consumer preference.

While improving texture perception of reduced sugar RTD dairy beverages, the long shelf-life stability of the beverage cannot be compromised. Such stability is challenging because aseptically processed, flavored dairy beverages experience inherent gelation over time. Stabilizer ingredients added to the beverage to prevent sedimentation of particles in the beverage, such as cocoa, increase susceptibility to gelation by interacting with each other and with milk proteins. Substantially reducing or removing milk fat, cocoa and/or sugar in flavored milk beverages can also contribute to gelation, resulting in a shorter shelf-life.

There are no current solutions for shelf stable RTD flavored dairy beverages with low sugar content which have a mouthfeel similar to full sugar beverages and are shelf-stable during the life of the beverage.

### SUMMARY

The present disclosure provides ready-to-drink flavored dairy beverages and also provides methods for making such beverages. The ready-to-drink flavored dairy beverages can have reduced sugar, can be aseptic, and can have a pleasant mouthfeel. The ready-to-drink flavored dairy beverages can have an improved physico-chemical stability during ambient storage times e.g., stable for at least three months in ambient storage and preferably at least six months in ambient storage. The dairy beverages exhibits reduced gelation and overcome problems with other phase separation/instability issues during different storage conditions over the full life of the dairy beverages.

In a general embodiment, a ready to drink beverage is provided. The beverage includes: a dairy component; a flavor component selected from the group consisting of a cocoa component, a fruit flavor component, and a combination thereof, and a stabilizing system comprising a first stabilizing component and a second stabilizing component, the first stabilizing component comprises microcrystalline cellulose (MCC) and carboxymethyl cellulose (CMC) and the second stabilizing component is selected from the group consisting of gellan, a modified starch and a combination thereof.

In a related embodiment, the first stabilizing component further comprises carrageenans, such as kappa carrageenan.

In a related embodiment, the first stabilizing component is present in the beverage in an amount from 0.02% to 0.3% of the beverage.

In a related embodiment, the second stabilizing component comprises gellan present in the beverage in an amount from 0.01% to 0.075% of the beverage.

In a related embodiment, the second stabilizing component may further comprise modified starch. The modified starch can be present in the beverage in an amount from 0.05% to 0.75% of the beverage.

In a related embodiment, the second stabilizing component comprises gellan from 0.01% to 0.075% of the beverage, and modified starch from 0.05% to 0.75% of the beverage.

In a related embodiment, sugar is present in the beverage in an amount up to about 4.5% of the beverage.

In another embodiment, a method of producing a ready to drink dairy beverage is provided. The method includes adding a stabilizing system to a dairy component and a flavor component, the flavor component selected from the group consisting of a cocoa component, a fruit flavor component, and a combination thereof, and the stabilizing system comprises a first stabilizing component that is 0.02% to 0.3% of the beverage and a second stabilizing component is present in the beverage in an amount from 0.01% to 0.75% of the beverage. In an embodiment, the second stabilizing component is gellan and the beverage comprises 0.01% to 0.075% of gellan. In another embodiment, the second stabilizing component is modified starch and the beverage comprises 0.05% to 0.75% of modified starch. In yet another embodiment, the second stabilizing component comprises, or consists essentially of, gellan and modified starch, and gellan is present in an amount from 0.01% to 0.075% of the beverage, and modified starch is present in an amount from 0.05% to 0.75% of the beverage.

The first stabilizing component comprises microcrystalline cellulose (MCC) and carboxymethyl cellulose (CMC) and the second stabilizing component is selected from the group consisting of gellan, a modified starch and a combination thereof.

In a related embodiment, the method further includes producing the beverage to have reduced sugar as determined by a governmental regulation.

In another embodiment, a ready to drink aseptic beverage is provided. The beverage includes: a dairy component; a flavor component selected from the group consisting of a cocoa component, a fruit flavoring component, and a combination thereof; sugar in an amount up to about 4.5% of the beverage; and a stabilizing system comprising a first stabilizing component and a second stabilizing component, the first stabilizing component comprises microcrystalline cellulose (MCC) and carboxymethyl cellulose (CMC) and the second stabilizing component is selected from the group consisting of gellan, a modified starch and a combination thereof, and the stabilizing system is present in an amount that maintains the ready to drink aseptic beverage in a homogenous state for at least three months in ambient storage.

In a related embodiment, the first stabilizing component and the second stabilizing component are the only stabilizers in the beverage.

The first stabilizing component and the second stabilizing component can be the only stabilizers in the beverage.

In another embodiment, gellan, cellulose and carrageenan are present in a ratio by weight of about (0.7 to 15) to about (2 to 40) to 1.

In another embodiment, hydroxypropyl starch, cellulose and carrageenan are present in a ratio by weight of about (3.3 to 150) to about (2 to 40) to 1.

An advantage of the present disclosure is to provide an improved ready to drink shelf-stable flavored dairy beverage.

Another advantage of the present disclosure is to provide a ready to drink flavored dairy beverage that has an acceptable stability and desired shelf life during extended storage.

Still another advantage of the present disclosure is to provide a ready to drink flavored dairy beverage having reduced sugar that maintains a pleasant mouthfeel, body, smooth texture during the shelf-life.

Yet another advantage of the present disclosure is to provide a ready to drink flavored dairy beverage that has stability despite reduced sugar.

Another advantage of the present disclosure is to provide a ready to drink flavored dairy beverage that has reduced sugar but a mouthfeel similar to a full sugar beverage.

Still another advantage of the present disclosure is to provide a stabilizer system that maintains a cocoa component in suspension in a dairy medium and/or water.

Yet another advantage of the present disclosure is to provide a ready to drink flavored dairy beverage having an amount of sugar reduced by about 25% or more and preferably about 40% or more relative to typical shelf-stable ready to drink flavored beverages containing dairy.

Another advantage of the present disclosure is to provide a ready to drink reduced sugar flavored dairy beverage that does not have or does not rely on polyphosphates for stability.

Additional features and advantages are described herein, and will be apparent from, the following Detailed Description.

### DETAILED DESCRIPTION

All percentages expressed herein are by weight of the total weight of the composition unless expressed otherwise. When reference is made to the pH, values correspond to pH measured at 25° C. with standard equipment. As used in this disclosure and the appended claims, the singular forms “a,” “an” and “the” include plural referents unless the context clearly dictates otherwise. As used herein, “about” is understood to refer to numbers in a range of numerals. Moreover, all numerical ranges herein should be understood to include all integer, whole or fractions, within the range.

As used herein, “comprising,” “including” and “containing” are inclusive or open-ended terms that do not exclude additional, unrecited elements or method steps. However, the beverages provided by the present disclosure may lack any element that is not specifically disclosed herein. Thus, any embodiment defined herein using the term “comprising” includes embodiments “consisting essentially of” and “consisting of” the disclosed components.

As used herein, “ambient storage” means storage at temperatures that are commonly measured in warehouses, in transport vehicles, in shelves or storage zone at the retailers' premises, or in the consumer's cupboard. For instance, ambient temperature may range from 15° C. up to 35° C.

The present disclosure relates to shelf-stable RTD beverages containing a flavor component and one or more dairy ingredients (hereinafter “the beverage” or “the beverages”). “Ready-to-drink beverage” means a beverage in liquid form that can be consumed without further addition of liquid. The beverages can have reduced sugar. For example, the beverages can have an amount of sugar that is reduced by about 25% or more and preferably by about 40% or more relative to typical shelf-stable RTD flavored beverages containing dairy. As another example, the beverages can have “low sugar” or “reduced sugar” based on any applicable governmental regulation regarding such product statements. For example, a “low sugar” beverage contains less than 4.5 g added sugar per 100 gram of the beverage. “Added sugar” refers to caloric mono- and di-saccharides added during manufacture of the beverage, such as glucose, sucrose, maltose, fructose. However, lactose is naturally found in milk, therefore, for the purpose of this disclosure, lactose is not taken into account in “added sugar”.

As used herein, the word “cellulose” refers to any combination consisting essentially of microcrystalline cellulose (MCC) and carboxymethyl cellulose (CMC), also known as colloidal cellulose.

The beverages can be aseptic and can be stabilized by a complex stabilizing system containing a first component that is microcrystalline cellulose (MCC), carboxymethyl cellulose (CMC) and optionally carrageenans, such as kappa carrageenan, and a second component that is gellan and/or a modified starch.

A unique combination of components was found for a stabilizing system that can provide reduced sugar aseptic RTD flavored dairy beverages with good physico-chemical stability during storage while also providing good mouthfeel and a pleasant, indulgent taste. The stabilizing system improves the stability of reduced-sugar aseptic shelf-stable RTD flavored dairy beverages by helping to significantly reduce undesirable gelation of the beverage at ambient temperatures as well as other temperatures.

In a general embodiment, the beverage comprises a flavor component, a dairy component, and a stabilizing system. The flavor component can be a cocoa component and/or a fruit flavoring component. In an embodiment, the flavor component is present in the beverage in an amount from about 0.025% to about 1.0% of the beverage. The cocoa component can include one or more natural cocoas, alkalized cocoas, or other cocoa or chocolate based products. The fruit flavor component may include one or more fruit juices, soluble fruit powders, fruit extracts, fruit concentrates, fruit flavor crystals, fruit flavored powders, and the like. The fruit or fruit flavoring may be apple, orange, pear, peach, strawberry, banana, vanilla, cherry, pineapple, kiwi, grape, blueberry, raspberry, mango, guava, cranberry, blackberry or combinations thereof.

The dairy component can include one or more dairy ingredients or dairy substitute ingredients. For example, the dairy ingredients can be milk, milk fat, milk powder, skim milk, milk proteins and combinations thereof. Examples of suitable dairy proteins are casein, caseinate, casein hydrolysate, whey, whey hydrolysate, whey concentrate, whey isolate, milk protein concentrate, milk protein isolate, and combinations thereof. Furthermore, the dairy protein may be, for example, sweet whey, acid whey, α-lactalbumin, β-lactoglobulin, bovine serum albumin, acid casein, caseinates, α-casein, β-casein and/or γ-casein. Suitable dairy substitute ingredients include soy proteins, rice proteins and combinations thereof, for example. In an embodiment, the beverage comprises at least one of skim milk, whole pasteurized milk or non-fat milk powder. In a preferred embodiment, the beverage does not have added oil.

The stabilizing system has a first stabilizing component comprising microcrystalline cellulose (MCC) and carboxymethyl cellulose (CMC). In an embodiment, the first stabilizing component further comprises carrageenans, such as kappa carrageenan. The first stabilizing component can be present in an amount of 0.03% to 0.20% of the beverage, preferably from 0.05% to 0.19%, more preferably from 0.10% to 0.15%.

The stabilizing system has a second stabilizing component that is at least one of gellan or modified starch. Preferably, the gellan is high acyl gellan. The modified starch can be a physically modified and/or chemically modified starch, and non-limiting examples of suitable starch sources include wheat, barley, rye, rice, tapioca, potato and corn. In an embodiment, the second stabilizing component is present in an amount up to 0.825 wt % of the beverage, such as up to 0.5% of the beverage, such as about 0.1% of the beverage for example.

In an embodiment, the first stabilizing component and the second stabilizing component are the only the stabilizers in the beverage.

The beverage can be made aseptic to achieve commercial sterility and food safety standard for consumption. Aseptic treatment of the beverage may be performed by pre-heating the beverage, for example to about 75 to 85° C., and then injecting steam into the beverage to raise the temperature to about 140 to 160° C., for example at about 150° C. The beverage may then be cooled, for example by flash cooling, to a temperature of about 75 to 85° C., homogenized again, further cooled to about room temperature and filled into containers, such as cans. Suitable apparatuses for aseptic treatment of the beverage are commercially available. The stabilizing system can maintain the aseptic RTD dairy beverage in a homogenous state for three months in ambient storage and preferably at least six months in ambient storage. In the context of this disclosure, shelf-life stability may be assessed at 20° C. during 6 months, and 30° C. for 3 months, and 1 months at 38° C.

The combination of the disclosed amounts of MCC, CMC, optionally carrageenans, and at least one of gellan or a modified starch, was found to assist in maintaining good suspension and emulsion stability of the beverage, reducing gelation and other phase separation issues during the storage, and improving mouthfeel. For example, the stabilizing system can maintain the flavor component in suspension in an aqueous/dairy medium and stabilize proteins while also preventing or minimizing other phase separation issues.

The beverages can also include one or more additional ingredients such as flavorants, artificial sweeteners, natural sweeteners, colorants or a combination thereof. Sweeteners can be sugar-based, such as sucrose, invert syrup, fructose syrup, glucose syrup with various DE, maltodextrins with various DE and combinations thereof, for example. Sugarless sweeteners can include, but are not limited to, sugar alcohols such maltitol, xylitol, sorbitol, erythritol, mannitol, isomalt and lactitol, hydrogenated starch hydrolysates, saccharin, cyclamate, acetosulfame, an L-aspartyl-based sweetener, or mixtures thereof.

Usage level of the flavorants, sweeteners and colorants will vary greatly and will depend on such factors as potency of the sweetener, desired sweetness of the beverage, the level and type of flavor used, and cost considerations. Any suitable combinations of added sugar and/or sugarless sweeteners may be used in the beverages. In an embodiment, added sugar is present in an amount from about 0% to about 4.5% of the beverage, such as about 1% to about 4.2% or about 2% to about 4% of the beverage.

In an embodiment, the beverage does not have artificial sweetener. In an embodiment, the beverage is a low sugar beverage. Non-limiting examples of suitable flavorants include chocolate enhancers, cream/dairy enhancers, vanilla flavors or a combination thereof. In an embodiment, the one or more flavorants are present in the beverage in an amount from about 0.025% to about 1% of the beverage in addition to the cocoa component and/or the fruit flavor component.

In an embodiment, the beverage further includes one or more vitamins and/or minerals. The vitamins can be present in the beverage in an amount from about 0.01% to about 0.5% of the beverage. The vitamins include, but are not limited to, vitamin C and group B vitamins, and other non-limiting examples of suitable vitamins include ascorbic acid, ascorbyl palmitate, vitamins B1, B2, B6, B12, and Niacin (B3), or combination of thereof. The vitamins may also include Vitamins A, D, E and K and acid vitamins such as pantothenic acid, folic acid and biotin. The Vitamin A may be present as Vitamin A Palmitate. Vitamin D3 is an example of a suitable Vitamin D.

The minerals can be present in the beverage in an amount from about 0.0025% to about 1% of the beverage. Non-limiting examples of the minerals include calcium, magnesium, iron or a combination thereof. The source of calcium can include calcium carbonate, calcium phosphate, calcium citrate, other insoluble calcium compounds or a combination thereof. The source of magnesium can include magnesium phosphate, magnesium carbonate, magnesium hydroxide or combination of thereof. The source of iron can include iron ammonium phosphate, ferric pyrophosphate, ferric phosphate, ferrous phosphate, other insoluble iron compounds, aminoacids, iron chelating compounds such as EDTA, or combinations thereof. The minerals may also include zinc, iodine, copper, phosphorus, manganese, potassium, chromium, molybdenum, selenium, nickel, tin, silicon, vanadium and boron.

The ready to drink beverages can be made using any suitable process. For example, a process of making the beverages includes dissolving the raw materials in fluid milk/water and hydration (e.g., wetting) of a flavor component such as cocoa powder or fruit flavor powder for about 45 minutes to about 90 minutes at about 90° C. to about 95° C. to form the beverage. The beverage can then be subjected to ultra high temperature (“UHT”) heat treatment at about 140° C. to about 151° C. for about 2 seconds to about 12 seconds and aseptic homogenization from about 30 bars to about 300 bars. The UHT heat treatment can be followed by aseptic filling of the ready to drink beverage into a suitable container.

### EXAMPLES

By way of example and not limitation, the following examples are illustrative of various embodiments of the present disclosure.

### Example 1

A control aseptic liquid dairy beverage was prepared, containing 200 ppm of additional carrageenan, 0.1% gellan, and 0.15% of a first stabilizing component (MCC, CMC and 150 ppm carrageenan). A sample aseptic liquid dairy beverage according to the present disclosure was also prepared, containing 0.1% gellan and 0.15% of the same stabilizing component. Both control beverage and sample beverage contain about 3% of milk protein, about 1% of milk fat, about 4% of added sugar, and about 0.1% of alkalized cocoa, in the total beverage.

When compared with the control beverage, the sample beverage lacks the additional carrageenan. After 3 months storage at 20° C.), unacceptable gel formation occurred in the control beverage, and much reduced gel formation occurred in the beverage according to the present disclosure.

### Example 2

A control aseptic liquid dairy beverage was prepared, containing 1% modified starch, 200 ppm of carrageenan, and 0.15% of a first stabilizing component. A sample aseptic liquid dairy beverage according to the present disclosure was prepared containing 1% modified starch and 0.15% of the first stabilizing component. Both control beverage and sample beverage contain about 3% of milk protein, about 1% of milk fat, about 4% of added sugar, and about 0.1% of alkalized cocoa, in the total beverage.

When compared with the control beverage, the sample beverage lacks the additional carrageenan. After 3 months storage at 20° C., unacceptable gel formation occurred in the control beverage, and much reduced gel formation occurred in the beverage according to the present disclosure.

### Example 3

A non-limiting example formulation is set forth in the below table listed the key ingredients of aseptic, flavored milk containing the first stabilizer system and gellan.

| Ingredients | Range (w/w %) |
|---|---|
| Milk fat | 0.3-2 |
| Alkalized Cocoa | 0.1-2 |
| Added Sugar | 0-4.5 |
| High Acyl Gellan | 0.01-0.075 |
| Cellulose | 0.02-0.3 |
| Carrageenan | 0.005-0.015 |
| Skim Milk | remain |

### Example 4

A non-limiting example formulation is set forth in the below table listed the key ingredients of aseptic, flavored milk containing the first stabilizer system and starch.

| Ingredients | Range (w/w %) |
|---|---|
| Milk fat | 0.3-2 |
| Alkalized Cocoa | 0.1-2 |
| Added Sugar | 0-4.5 |
| Hydroxypropyl starch | 0.05-0.75 |
| Cellulose | 0.02-0.3 |
| Carrageenan | 0.005-0.015 |
| Skim Milk | remain |

### Example 5

A non-limiting example formulation is set forth in the below table listed the key ingredients in aseptic, flavored milk containing the first stabilizer system and in combination of gellan and modified starch.

| Ingredients | Range (w/w %) |
|---|---|
| Milk fat | 0.3-2 |
| Alkalized Cocoa | 0-2 |
| Added Sugar | 0-4.5 |
| High Acyl Gellan | 0.01-0.075 |
| Hydroxypropyl starch | 0.05-0.75 |
| Cellulose | 0.02-0.3 |
| Carrageenan | 0.005-0.015 |
| Skim Milk | remain |

The above recipes may also comprise milk cream to adjust fat level, milk protein to comply with regulation. It may also include minerals, e.g. calcium carbonate, for mineral fortification.

The recipes can also contain different flavors and sweeteners.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1: A ready to drink beverage consisting essentially of:
0.3-2 wt % of milk fat;
0.1-2 wt % of a cocoa component;
a stabilizing system consisting essentially of a first stabilizing component and a second stabilizing component,
the first stabilizing component is (1) microcrystalline cellulose (MCC) and carboxymethyl cellulose (CMC) in a total amount of 0.02-0.3 wt. % of the ready to drink beverage; and (2) carrageenan from 0.005 wt. % to 0.015 wt. % of the ready to drink beverage,
the second stabilizing component is high acyl gellan in an amount from 0.01 wt. % to 0.075 wt. % of the ready to drink beverage,
the stabilizing system is present in an amount that maintains the ready to drink beverage in a substantially homogenous state for at least three months in ambient storage;
0-4.5 wt. % of added sugar; and
skim milk.

2: The ready to drink beverage of claim 1, wherein a weight ratio of the high acyl gellan:cellulose:the carrageenan ranges from about 0.7:40:1 to about 15:2:1.

3: A ready to drink aseptic beverage consisting essentially of:
0.3-2 wt % of milk fat;
0.1-2 wt % of a cocoa component;
up to about 4.5 wt. % of added sugar; and
a stabilizing system consisting essentially of a first stabilizing component and a second stabilizing component,
the first stabilizing component is (1) microcrystalline cellulose (MCC) and carboxymethyl cellulose (CMC); and (2) carrageenan from 0.005 wt. % to 0.015 wt. % of the beverage,
the second stabilizing component is hydroxypropyl starch in an amount from 0.05 wt. % to 0.75 wt. % of the ready to drink aseptic beverage, the stabilizing system is present in an amount that maintains the ready to drink aseptic beverage in a homogenous state for at least three months in ambient storage; and
skim milk.

4: A ready to drink beverage comprising:
0.3-2 wt % of milk fat;
0.1-2 wt % of a cocoa component;
0-4.5 wt. % of added sugar;
skim milk; and
a stabilizing system consisting essentially of:
0.02-0.3 wt. % of cellulose;
0.005-0.015 wt. % of carrageenan;
0.01-0.075 wt. % of high acyl gellan; and
0.05-0.75 wt. % of hydroxypropyl starch.

5: The ready to drink beverage of claim 4, wherein the weight ratio of the hydroxypropyl starch:the cellulose:the carrageenan ranges from about 3.3:40:1 to about 150:2:1.

6: The ready to drink beverage of claim 1, wherein the ready to drink beverage consists essentially of the milk fat; the cocoa component; the stabilizing system; the added sugar; and the skim milk.

7: The ready to drink aseptic beverage of claim 3, wherein the ready to drink aseptic beverage consists essentially of the milk fat; the cocoa component; the stabilizing system; the added sugar; and the skim milk.

8: The ready to drink beverage of claim 4, wherein the ready to drink beverage consists essentially of the milk fat; the cocoa component; the added sugar; the skim milk; and the stabilizing system.
